(19) United States
(12) Patent Application Publication
(10) Pub. No.: US 2015/0021455 A1
(43) Pub. Date: Jan. 22, 2015

(54) TURBINE ENGINE SUPPORT PART OF HYBRID STRUCTURE

(71) Applicants: SAFRAN, Paris (FR); SNECMA, Paris (FR)

(72) Inventors: Robin Mandel, Paris (FR); Wouter Balk, Melun (FR); Nicolas Christian Raymond Leblond, Paris (FR); Jean-Yves Picart, Dammarie-Les-Lys (FR)

(73) Assignees: SAFRAN, Paris (JP); SNECMA, Paris (FR)

(21) Appl. No.: 14/377,644

(22) PCT Filed: Feb. 5, 2013
(86) PCT No.: PCT/FR13/50239

§ 371 Date: Aug. 8, 2014

(30) Foreign Application Priority Data
Feb. 9, 2012 (FR) 12 51198

(51) Int. Cl. F02C 7/32

(52) U.S. Cl. CPC F02C 7/32
USPC 248/554

(57) ABSTRACT

A turbine engine support part including a main structure made of composite material and a reinforcing secondary structure made of metal and integrated in the main structure, the secondary structure presenting a geometrical shape and dimensions configured to impart mechanical strength to the support part in event of the main structure being destroyed.

### BACKGROUND OF THE INVENTION

The present invention relates to the general field of turbine engine parts that are used as supports for fairings or supports for equipment.

More precisely, the invention relates to parts that are used in a turbojet for supporting engine components that convey a flammable fluid (such as kerosene or oil) or an oxidizer (such as air), and also parts that support components of the electronic equipment of the turbojet (such as the electronic computer constituting the engine control unit (ECU) of the turbojet, or the electronic computer of the thrust reverser control unit (TRCU)).

Such support parts are subjected to strict regulations concerning protection against a fire occurring in the fan compartment of the turbojet. Specifically, civil regulations require that these support parts must be capable of withstanding a fire for a length of time that is sufficiently long to prevent the supported component dropping off and thereby worsening the fire in the fan compartment of the turbojet.

Furthermore, reducing the weight of a turbojet has become a priority target for engine manufacturers. The parts forming bearing supports and equipment supports constitute a particular opportunity for achieving non-negligible weight savings. Having recourse to structural composite materials, and in particular to composite materials having a thermosetting or thermoplastic organic matrix, provides a solution to this problem. Specifically, compared with metal materials, such materials present sufficient mechanical strength for supporting loads while presenting less weight.

Nevertheless, the structural composite materials envisaged for making turbine engine support parts do not present sufficient mechanical strength when they are subjected to the heat of a flame representing a fire in the fan compartment of a turbojet.

### OBJECT AND SUMMARY OF THE INVENTION

It is thus desirable to be able to have turbine engine support parts that present weight savings compared with parts made of metal and that are capable of satisfying the criteria of civil regulations in terms of protection in the event of a fire.

For this purpose, according to the invention, there is proposed a turbine engine support part comprising a main structure made of composite material and a reinforcing secondary structure made of metal and integrated in the main structure, the secondary structure presenting a geometrical shape and dimensions suitable for imparting mechanical strength to the support part in the event of the main structure being destroyed.

The term “geometrical shape and dimensions suitable for imparting mechanical strength to the support part in the event of the main structure being destroyed” is used to mean in particular that the secondary structure presents a geometrical profile substantially identical to that of the main structure and a thickness that is sufficient to enable it, on its own, to withstand the mechanical loads to which the part is subjected at the end of a fire.

The support part of the invention is thus defined as being a hybrid part with a main structure made of composite material enabling the overall weight of the part to be reduced, and a reinforcing secondary structure of metal that serves to guarantee mechanical strength for the part in the event of a fire damaging the main structure made of composite material. As a result, the support part of the invention presents both overall weight that is lighter than a part made entirely out of metal and also a structure that is suitable for satisfying the requirements of regulations in terms of protection in the event of a fire.

The secondary structure of the support part may be integrated in the main structure by co-molding. Alternatively, the secondary structure may be integrated in the main structure by mounting the secondary structure in a groove in the main structure.

In the second configuration, the groove in the main structure in which the secondary structure is mounted may advantageously be made in the surface of the main structure. As a result, the secondary structure made of metal can serve to guarantee electrical conductivity for the support part, thereby making it easier to satisfy requirements for grounding the electronic equipment (ECU or TRCU) of the turbine engine that is supported by such a part.

The support part may further comprise means for fastening the support part on a rigid structure of the turbine engine, these means being joined to the main and secondary structures.

The main structure may be made of composite material comprising fiber reinforcement made of carbon fibers densified by a thermosetting or thermoplastic matrix, and the secondary structure may be made of stainless steel or of titanium.

The invention also provides a turbine engine including at least one support part as defined above.

### BRIEF DESCRIPTION OF THE DRAWINGS

Other characteristics and advantages of the present invention appear from the following description made with reference to the accompanying drawings, which show an implementation having no limiting character. In the figures:

FIG. 1 is a perspective and exploded view of an example of a support part in accordance with the invention;

FIG. 2 is a cutaway view of the FIG. 1 support part when assembled; and

FIG. 3 is a section view of a support part in accordance with the invention in another embodiment.

### DETAILED DESCRIPTION OF THE INVENTION

The invention is applicable to any part used in a turbojet for supporting a fairing or equipment, and in particular for supporting engine components for conveying a flammable fluid or an oxidizer, and components of the electronic equipment of the turbojet (such as the ECU or the TRCU).

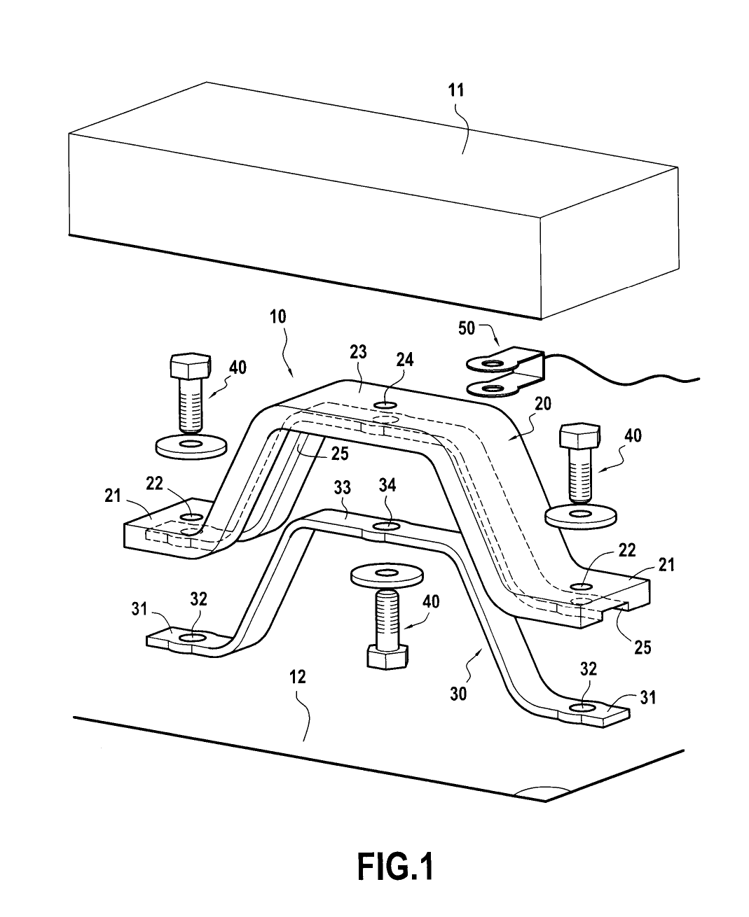

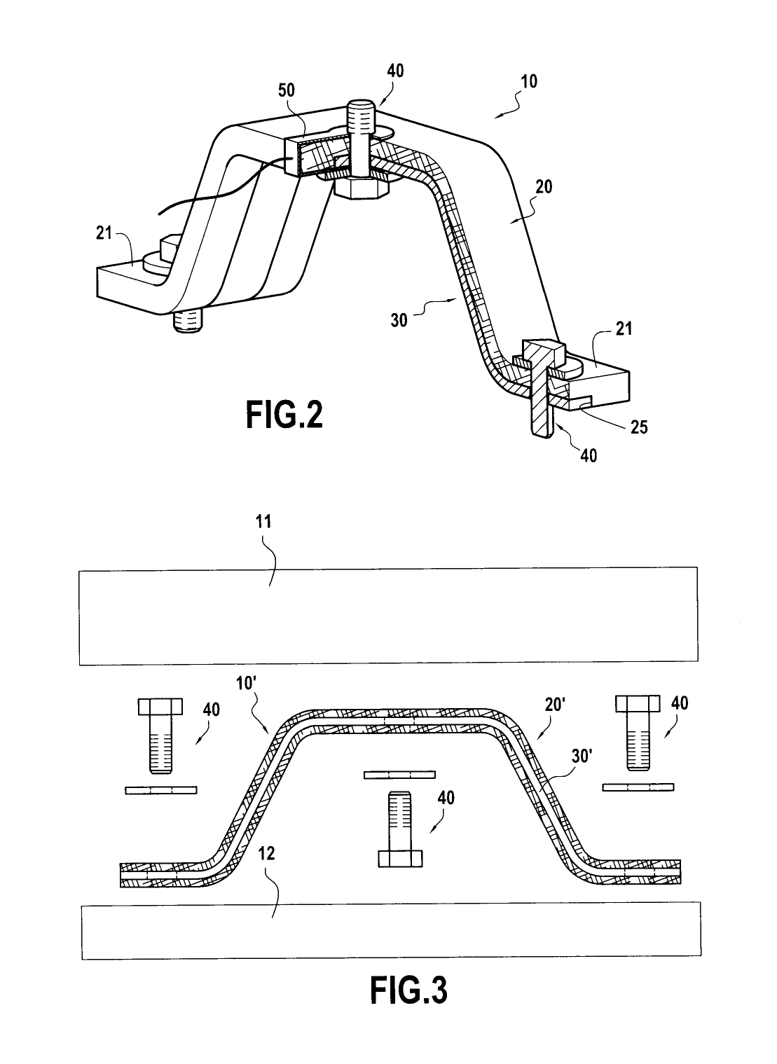

An example of such a support part is shown in FIGS. 1 and 2. This support part 10 is substantially elongate and presents the shape of a bridge, and in particular it may be used for supporting a component 11 of the electronic equipment of the turbojet, such as the ECU or the TRCU.

According to the invention, the support part 10 comprises a main structure 20 made of composite material and a reinforcing secondary structure 30 made of metal and integrated in the main structure, the secondary structure presenting a geometrical shape and dimensions suitable for imparting mechanical strength to the support part in the event of the main structure being destroyed.

By way of example, the main structure may be made of a composite material comprising fiber reinforcement made of carbon fibers and densified by a thermosetting matrix (of the epoxy type) or by a thermoplastic matrix (of the poly ether ether ketone (PEEK) type). Thermosetting matrices of epoxy type present great simplicity in working, and have excellent fatigue and creep properties, together with good temperature stability. Likewise, thermoplastic matrices of PEEK type present not only good mechanical properties (and in particular good resistance to fatigue), but also excellent temperature behavior.

The reinforcing secondary structure may be made of stainless steel or of titanium. Specifically, these two materials present the advantage of possessing good ability to withstand fire.

In the embodiment of FIGS. 1 and 2, the main structure 20 and the secondary structure 30 are thus each of substantially identical bridge shape with fastener tabs respectively referenced 21 and 31 at each of their two ends.

The ends 21, 31 of the two structures are provided with respective holes 22 and 32 that are mutually in alignment for passing bolts 40 for fastening the support part to a rigid structure 12 of the turbine engine.

Likewise, the central portions 23 and 33 of the main and secondary structures situated between the ends 21, 31 are provided with respective holes 24, 34 that are in alignment for passing bolts 40 for fastening the component 11 of the electronic equipment of the turbojet to the support part.

It should be observed that the holes 32, 34 made in the reinforcing secondary structure are of greater diameter than the holes 22, 24 formed in the main structure. Thus, in normal operation, only the main structure of composite material contributes to supporting the load exerted by the component 11 of the electronic equipment.

According to the invention, the secondary structure 30 presents a geometrical shape and dimensions that are suitable for imparting mechanical strength to the support part in the event of the main structure 20 being destroyed, in particular by fire. In particular, as shown in FIG. 1, the reinforcing secondary structure presents a geometrical profile that is identical to that of the main structure. In particular, it extends between the two ends of the main structure. Furthermore, the secondary structure presents sufficient thickness (relative to the metal material used for fabricating it and relative to the load exerted by the component 11 of the electronic equipment) to enable it on its own to support the load exerted by this component in the event of the main structure made of composite material being destroyed, and to do so at least for some minimum duration.

By way of example, for a load exerted by the component 11 of the electronic equipment weighing 15 kg and subjected to an acceleration of 4 g, it is possible to make a secondary structure out of stainless steel having a width of 10 millimeters (mm) and a thickness of 2 mm, approximately.

Furthermore, in the embodiment of FIGS. 1 and 2, the reinforcing secondary structure 30 is integrated in the main structure 10 by mounting the secondary structure in a groove 25 (or trench) in the main structure. More precisely, the groove 25 of the main structure is formed in the surface facing the rigid structure 12 of the turbojet on which the support part is mounted. As a result, the reinforcing secondary structure also serves to guarantee that the support part is electrically conductive.

The secondary structure made of metal is mounted in the groove 25 of the main structure and it is held therein firstly by the bolts 40 passing through these two structures, and secondly by an adhesive paste of the type constituted by the mastic that is usually used for composite-to-metal interfaces.

Assembling the reinforcing secondary structure made of metal material in a groove in the surface of the main structure in this way also serves to comply more easily with requirements for grounding the electronic equipment of the turbojet as supported by the support part 10. Specifically, and as shown in FIG. 2, this grounding may be performed by a conductive clamp 50 that is in contact in particular with the secondary structure made of metal.

In the embodiment shown in FIG. 3, the secondary structure 30′ of the support part 10′ is integrated in the main structure 20′ by co-molding. For this purpose, the secondary structure is molded inside the main structure during the step of molding the fiber preform that is for use in fabricating the main structure made of composite material.

Naturally, and in more general manner, the reinforcing part may have a shape different from that shown in FIGS. 1 to 3.

1-7. (canceled)

8. A turbine engine support part comprising:
a main structure made of composite material; and
a reinforcing secondary structure made of metal and integrated in the main structure,
the secondary structure presenting a geometrical shape and dimensions configured to impart mechanical strength to the support part in event of the main structure being destroyed.

9. A support part according to claim 8, wherein the secondary structure is integrated in the main structure by co-molding.

10. A support part according to claim 8, wherein the secondary structure is integrated in the main structure by mounting the secondary structure in a groove in the main structure.

11. A support part according to claim 10, wherein the groove is made in a surface of the main structure.

12. A support part according to claim 8, further comprising means for fastening the support part on a rigid structure of the turbine engine, the means joined to the main and secondary structures.

13. A support part according to claim 8, wherein the main structure is made of composite material comprising fiber reinforcement made of carbon fibers densified by a thermosetting or thermoplastic matrix, and the secondary structure is made of stainless steel or of titanium.

14. A turbine engine including at least one support part according to claim 8.
